(19) United States
(12) Patent Application Publication
(10) Pub. No.: US 2018/0327280 A1
(43) Pub. Date: Nov. 15, 2018

(54) Methods and Compositions for Removing Fluoride from Water

(71) Applicant: THE REGENTS OF THE UNIVERSITY OF CALIFORNIA, Oakland, CA (US)

(72) Inventors: Aruna K. Cherukumilli, Berkeley, CA (US); Ashok Jagannath Gadgil, El Cerrito, CA (US)

(21) Appl. No.: 15/777,128

(22) PCT Filed: Nov. 21, 2016
(86) PCT No.: PCT/US16/63171

§ 371 Date: May 17, 2018

Related U.S. Application Data
(60) Provisional application No. 62/257,611, filed on Nov. 19, 2015.

(51) Int. Cl. C02F 1/28; B01J 20/08; C02F 1/66

(52) U.S. Cl. CPC C02F 1/281; C02F 2101/14; C02F 1/66; B01J 20/08

(57) ABSTRACT

The present invention provides for a system for removing a fluoride ion from an aqueous solution, comprising: (a) an aqueous solution comprising a fluoride ion, and (b) a bauxite mineral; wherein the aqueous solution has a pH with a value in the range of from about 5.5 to about 8.5, and the system is capable of achieving an aqueous solution having a fluoride concentration of equal to or less than 1.5 ppm.

### CROSS-REFERENCE TO RELATED APPLICATIONS

The application claims priority to International Patent Application Ser. No. PCT/US2016/063171, filed Nov. 21, 2016, which claims priority to U.S. Provisional Patent Application Ser. No. 62/257,611, filed Nov. 19, 2015; which are incorporated herein by reference.

### STATEMENT OF GOVERNMENTAL SUPPORT

The invention described and claimed herein was made in part utilizing funds supplied by the U.S. Department of Energy under Contract No. DE-AC02-05CH11231. The government has certain rights in this invention.

### FIELD OF THE INVENTION

This invention relates generally to removal of fluoride ions from water.

### BACKGROUND OF THE INVENTION

Globally, 200 million people are at risk of developing crippling deformities (e.g. dental/skeletal fluorosis) and other detrimental health effects by drinking groundwater contaminated with toxic levels of naturally occurring fluoride. In India alone, 66 million people consume groundwater with fluoride levels above the WHO guideline value (1.5 mg F⁻/L), subsequently facing adverse socio-economic and health effects. For example, despite decades of awareness of fluoride contamination in Nalgonda District, Telangana, India, this problem persists due to the lack of affordable groundwater treatment technologies and surface water alternatives. Due to the high fluoride content in local aquifers and the population's heavy reliance on groundwater, an estimated 10% of the district population is affected by fluoride contamination and over 10,000 people are irreversibly crippled by skeletal fluorosis.

Although many fluoride removal technologies have been shown to be effective in the laboratory, few are sustainable in rural remote areas like Nalgonda because they are either culturally inappropriate (e.g., bone char), unreliable (e.g., dilution through rainwater harvesting), labor intensive and difficult to scale up (a commonly cited problem of the ‘Nalgonda technique’), or cost-prohibitive and complex to operate (e.g., reverse osmosis and activated alumina).

Current literature does not show that (1) many varieties of bauxite with a broad range of compositions can be modified to be a good adsorbent of fluoride ions, (2) the bauxites tested do not produce the level of desired removal, and (3) do not teach that the pH of the bauxite dramatically affects the performance of the bauxite in adsorbing fluoride ions.

### SUMMARY OF THE INVENTION

The present invention provides for a system for removing a fluoride ion from an aqueous solution, comprising: (a) an aqueous solution comprising a fluoride ion, and (b) a bauxite mineral; wherein the aqueous solution has a pH with a value in the range of from about 5.0 to about 7.5, and the system is capable of achieving an aqueous solution having a fluoride concentration of equal to or less than 1.5 ppm.

In some embodiments, the system is capable of achieving an aqueous solution having a fluoride concentration of equal to or less than 1.4 ppm. In some embodiments, the system is capable of achieving an aqueous solution having a fluoride concentration of equal to or less than 1.3 ppm. In some embodiments, the system is capable of achieving an aqueous solution having a fluoride concentration of equal to or less than 1.2 ppm. In some embodiments, the system is capable of achieving an aqueous solution having a fluoride concentration of equal to or less than 1.1 ppm. In some embodiments, the system is capable of achieving an aqueous solution having a fluoride concentration of equal to or less than 1.0 ppm. In some embodiments, the bauxite mineral is first treated by mechanically breaking the bauxite mineral into smaller pieces, such as by milling. In some embodiments, the bauxite mineral the smaller pieces have an average diameter, or the length of the longest linear dimension, of equal to or less than about 1 mm. In some embodiments, the bauxite mineral the smaller pieces have an average diameter, or the length of the longest linear dimension, of equal to or less than about 100 μm, 50 μm, 25 μm, 20 μm, 15 μm, or 10 μm.

In some embodiments, the bauxite mineral is first treated to dry the mineral or remove water from the mineral, such as by heating. In some embodiments, the bauxite mineral is first heated at a temperature equal to or more than about 300° C., such as in an oven, prior to introduced or mixed with the aqueous solution. In some embodiments, the bauxite mineral is a global bauxite mineral.

The present invention provides for a method for removing a fluoride ion from an aqueous solution comprising: (a) providing an aqueous solution comprising a fluoride ion; (b) introducing a bauxite mineral to the aqueous solution; (c) adjusting the pH of the aqueous solution to a value in the range of from about 5.5 to about 6.5 such that the fluoride ion binds to the bauxite mineral to form a bauxite-fluoride complex, wherein the fluoride ion adsorbs and forms an innerspace aluminum-fluoride complex; (d) optionally incubating the aqueous solution for a period of time sufficient for the fluoride ion to bind to the bauxite mineral to form the bauxite-fluoride complex; (e) separating the bauxite-fluoride complex from the aqueous solution to produce a fluoride ion reduced aqueous solution, such that the fluoride ion reduced aqueous solution has a fluoride content of equal to or less than 1.5 ppm; (f) optionally adjusting the pH value of the aqueous solution to a value in the range of from about 6.5 to about 7.5; and (g) optionally extracting alumina (Al₂O₃) and/or aluminum from the bauxite-fluoride complex. In some embodiments, the fluoride ion reduced aqueous solution has a fluoride content of equal to or less than 1.0 ppm.

The present invention provides for a method for removing a fluoride ion from an aqueous solution comprising: (a) providing an aqueous solution comprising fluoride, one or more cations, such as calcium and magnesium, and one or more anions, such as bicarbonate and sulfate; (b) introducing a processed bauxite mineral to the aqueous solution via a batch or continuous addition process, wherein the processed bauxite mineral to account for native pH and mineralogy differences depending on the type of bauxite used, such that the processed bauxite mineral and the fluoride ion complex to form a solid precipitate; and (c) separating the solid precipitate from the aqueous solution, such that the resulting aqueous solution has a fluoride content of equal to or less than 1.5 ppm. In some embodiments, the resulting aqueous solution has a fluoride content of equal to or less than 1.0 ppm. In some embodiments, the method is a continuous process, wherein the method takes place in a reactor, step (b) results in a bauxite slurry wherein processed bauxite mineral is continuously introduced to the bauxite slurry, and step (c) results in the solid precipitate being continuously separated from the bauxite slurry.

In some embodiments, the aqueous solution is naturally occurring groundwater contaminated with fluoride ions. In some embodiments, the separating step (c) comprises using a sedimentation or post treatment filtration process to remove solid precipitates from the treated solution. In some embodiments, processed bauxite mineral is formed by (i) burning off organic matter at a temperature equal to or more than 200° C., or (ii) milling the processed bauxite mineral into a plurality of particles having (1) an average particle size with a maximum linear dimension of equal or less than 50 μm, or (2) a maximum linear dimension of equal or less than 50 μm, and introducing one or more acidic functional groups to the surface of the particles. In some embodiments, the plurality of particles has (1) an average particle size with a maximum linear dimension of equal or less than 25 μm, or (2) a maximum linear dimension of equal or less than 25 μm. In some embodiments, the plurality of particles has (1) an average particle size with a maximum linear dimension of equal or less than 20 μm, or (2) a maximum linear dimension of equal or less than 20 μm. In some embodiments, the plurality of particles has (1) an average particle size with a maximum linear dimension of equal or less than 15 μm, or (2) a maximum linear dimension of equal or less than 15 μm. In some embodiments, the plurality of particles has (1) an average particle size with a maximum linear dimension of equal or less than 10 μm, or (2) a maximum linear dimension of equal or less than 10 μm.

The present invention provides for a method for removing naturally relevant concentrations of fluoride ions from contaminated groundwater comprising: (a) providing an aqueous solution comprising fluoride and other ions, such as bicarbonate, calcium, magnesium, sulfate, or the like; (b) introducing a processed bauxite mineral (to account for pH and mineralogy differences) to the aqueous solution via a batch or continuous addition process; and (3) using a sedimentation or post treatment filtration process to remove solid precipitates from the treated solution.

In some embodiments, the aqueous solution has a pH with a value in the range of from about 5.5 to about 6.5. In some embodiments, the aqueous solution has a pH with a value in the range of from about 5.6 to about 6.4. In some embodiments, the aqueous solution has a pH with a value in the range of from about 5.7 to about 6.3. In some embodiments, the aqueous solution has a pH with a value in the range of from about 5.8 to about 6.2. In some embodiments, the aqueous solution has a pH with a value in the range of from about 5.9 to about 6.1. In some embodiments, the aqueous solution has a pH with a value of about 6.0.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1A shows the minimum dose of Africa Bauxite vs. Activated Alumina Required to Reach WHO limit, i.e. 1.5 ppm, in different waters.

FIG. 1B shows the annual per capita materials cost for clean water defluoridated using activated alumina (calculated using the daily WHO requirement for drinking water (7.5 L/person/day) and the material market prices of activated alumina (2$/kg) and bauxite 0.04/kg)).

FIG. 2A shows the minimum dose of various global bauxite samples required to reach WHO limit in different waters.

FIG. 2B shows the Annual per capita materials cost of clean water defluoridated the different bauxites (calculated using the daily WHO requirement for drinking water (7.5 L/person/day) and the material market prices of activated alumina (2/kg) and bauxite 0.04/kg)).

FIG. 3 shows 6 g/L bauxite and 4 g/L Activated alumina in synthetic Sri Lankan groundwater. Aqueous fluoride concentrations were measured at 1, 3, 5, 8, and 24 hours and final measured pH was 6.4. Average contact time to reach equilibrium was ˜3 hours for both adsorbents.

FIG. 4 shows the costs and environmental impacts associated with AA and Al production.

FIG. 5A shows the minimum dose of milled Guinea bauxite and unmodified Activated Alumina (AA) required to remediate initial fluoride concentrations (indicated in parentheses) to the WHO-MCL in various real and synthetic groundwater matrices.

FIG. 5B shows comparison of annual per capita material cost of defluoridation using AA in dispersive or regenerative mode and milled Guinea bauxite in dispersive mode.

FIG. 6 shows the minimum dose of unmodified Activated Alumina and three globally sourced bauxites (from Guinea, USA, and India) required to reach the WHO-MCL from initial fluoride concentrations of 10 mg/L in several groundwater matrices.

FIG. 7 shows fluoride concentration as a function of contact time for Activated Alumina (dose: 4 g/L) and Guinea Bauxite (dose: 10 g/L) in a synthetic Sri Lankan groundwater matrix. Doses used represent the minimum required dosage to reduce initial fluoride concentrations of 10 mg/L to the WHO-MCL (1.5 mg/L) after 24 hours of contact time.

### DETAILED DESCRIPTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

### Definitions

In this specification and in the claims that follow, reference will be made to a number of terms that shall be defined to have the following meanings:

It must be noted that as used herein and in the appended claims, the singular forms “a”, “and”, and “the” include plural referents unless the context clearly dictates otherwise. Thus, for example, reference to “a bauxite” includes a plurality of such bauxites, and so forth.

The term “about” refers to a value including 10% more than the stated value and 10% less than the stated value.

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

These and other objects, advantages, and features of the invention will become apparent to those persons skilled in the art upon reading the details of the invention as more fully described below.

In some embodiments, the aqueous solution is adjusted to a pH with a value in the range of from about 5.6 to about 6.4. In some embodiments, the aqueous solution is adjusted to a pH with a value in the range of from about 5.7 to about 6.3. In some embodiments, the aqueous solution is adjusted to a pH with a value in the range of from about 5.8 to about 6.2. In some embodiments, the aqueous solution is adjusted to a pH with a value in the range of from about 5.9 to about 6.1. In some embodiments, the aqueous solution is adjusted to a pH with a value of about 6.0. In some embodiments, introducing step (b) results in the aqueous solution having a pH of a value in the range of from about 5.5 to about 6.5. In some embodiments, introducing step (b) results in the aqueous solution having a pH of a value in the range of from about 5.6 to about 6.4. In some embodiments, introducing step (b) results in the aqueous solution having a pH of a value in the range of from about 5.7 to about 6.3. In some embodiments, introducing step (b) results in the aqueous solution having a pH of a value in the range of from about 5.8 to about 6.2. In some embodiments, introducing step (b) results in the aqueous solution having a pH of a value in the range of from about 5.9 to about 6.1. In some embodiments, introducing step (b) results in the aqueous solution having a pH of about 6.0.

In some embodiments, the aqueous solution is a natural groundwater having a fluoride content of equal to or more than 5 ppm. In some embodiments, the aqueous solution is a natural groundwater having a fluoride content of equal to or more than 10 ppm.

Bauxite, an aluminum ore, is the world's main source of aluminum. In some embodiments, the bauxite comprises the minerals gibbsite (Al(OH)₃), boehmite (γ-AlO(OH)), and/or diaspore (α-AlO(OH)), mixed with the two iron oxides goethite and haematite, the clay mineral kaolinite (Al₂Si₂O₅(OH)₄), and/or small amounts of anatase TiO₂. In some embodiments, the bauxite is gibbsite, kaolinite, titanium rich bauxite (TRB), high aluminum content bauxite ore (HABO), high iron content bauxite ore (HFBO), refractory grade bauxite, feed bauxite, or the like, or a mixture thereof. In some embodiments, the bauxite is guinea bauxite, USA bauxite, India bauxite.

In some embodiments, the bauxite used is a raw bauxite ore directly mined from the earth. In some embodiments, the bauxite used is a bauxite directly mined from the earth and treated by heating the bauxite to remove or reduce any carbon containing material in the bauxite, and/or increasing the surface area of the bauxite, such as milling or ball milling the bauxite. In some embodiments, the bauxite used is a raw bauxite ore directly mined from the earth and treated by heating the raw bauxite ore to remove or reduce any carbon containing material in the bauxite, and/or increasing the surface area of the raw bauxite ore, such as milling or ball milling the raw bauxite ore. In some embodiments, the bauxite is first heated at a temperature equal to or more than about 300° C., such as in an oven.

In some embodiments, a surface of the bauxite used is first subjected to surface activation by introducing a positively charged functional group, such as a group II cation, such as Mg²⁺, Ca²⁺, Sr²⁺, and Ba²⁺, to the surface of the bauxite. The group II cation can be derived from a salt such as MgCl₂, CaCl₂, SrCl₂, BaCl₂, and the like. The presence of the positively charged functional group on the surface of the bauxite can increase the adsorption capacity of the bauxite due to increased electrostatic interactions between the positive cation and the negatively charged fluoride anions (F⁻).

To practice the present invention, it is not necessary to have raw bauxite intensively processed or refined to create a cost-competitive and technically-effective adsorbent for water-borne fluoride.

The advantages of at least some embodiments of the invention include, but are not limited to, the capability of operating without turbulence of the water or solution, the step of adding the bauxite can be separate from mixing the bauxite in the aqueous solution, that that step can be separate from the holding tank, which may be either a batch process, or a continuously stirred reactor, and the separation of bauxite can be practiced by any of the well known separation processes including but not limited to flocculation sedimentation, and settling, after which, the precipitate can be removed.

The invention having been described, the following examples are offered to illustrate the subject invention by way of illustration, not by way of limitation.

### Example 1

The present invention is capable of remediating fluoride through a community-scale batch adsorption process using a moderately processed bauxite, an aluminum-rich ore. The moderately processed bauxite is an excellent adsorbent for fluoride removal because it is (a) locally available and affordable, (b) highly effective at removing a wide range of fluoride concentrations, (c) culturally appropriate, (d) technically feasible and robust in a rural setting, and (e) easily operated and maintained with minimal manpower. In addition, eliminating the costly and energy-intensive process of refining bauxite to activated alumina—a commonly used adsorbent—reduces the annual per capita materials cost of treated water significantly, from ˜$50/person year using activated alumina to ˜$1/person year using bauxite. Preliminary results indicate that moderately processed bauxite is an excellent adsorbent for fluoride removal. It is primarily composed of the mineral gibbsite (Al(OH)₃), additional constituents (e.g., Fe(OH)₃ and SiO₂) do not hinder fluoride removal or negatively alter the quality of treated water, and a low dose (comparable to that required of activated alumina) can sufficiently remediate field-relevant fluoride concentrations (5-10 ppm F⁻) to below the WHO limit.

200 million people worldwide drink groundwater contaminated with toxic fluoride levels surpassing the World Health Organization's (WHO) maximum contaminant limit (MCL) of 1.5 mg F⁻/L. Although low fluoride concentrations (<1 mg F⁻/L) are often intentionally added to municipal drinking water supplies to prevent dental caries, exposure to excessive fluoride concentrations can cause detrimental health effects, including anemia and low IQ due to poor nutrient absorption, mottling and degradation of tooth enamel (dental fluorosis), and irreversible bone deformities in children (skeletal fluorosis). Dissolution of fluoride-rich granitic rocks in groundwater aquifers cause excessive levels of fluoride in arid regions of India, China, East African Rift Valley, the Middle East, northern Mexico, and central Argentina.

Although many technologies have proven to be effective in the lab, most are not sustainable or effective in remote rural areas because they are labor intensive, difficult to scale up at the community level (a commonly cited problem of the ‘Nalgonda technique’), cost-prohibitive and difficult to source locally (e.g., reverse osmosis and activated alumina), culturally inappropriate (e.g., bone char), or unreliable (e.g., dilution through rainwater harvesting).

Among these existing technologies, aluminum-based adsorbents (e.g. activated alumina filters and aluminum electrocoagulation) are widely used due to their relative affordability for the upper middle class, ease of operation, and fluoride's chemical affinity for aluminum. However, the industrial methods used to produce alumina and aluminum metals from bauxite ore (i.e., Bayer and Hall-Héroult processes) are extremely resource intensive in terms of money, energy and greenhouse gas emissions. Current industrial prices indicate a steep cost increase due to each processing step: per ton, alumina and aluminum respectively cost 10× and 100× more than raw bauxite ore. More specifically, once alumina is further activated to make the commonly used filter media, its final cost ($2000/ton) is 50× more expensive than raw bauxite ore ($40/ton).

Our aim is to develop for the first time a sustainable fluoride adsorbent using inexpensively processed bauxite mineral to eliminate the costly, wasteful, and unnecessary processes of refining bauxite into higher-end aluminum-based adsorbents. To develop our cost-competitive bauxite-based defluoridation technology, we need to challenge and overcome the assumptions that raw bauxite must be 1) intensively purified (using caustic sodium hydroxide) and 2) enhanced (through calcination at T>1100° C.). We believe our direct-bauxite solution has the potential to be (a) locally available and affordable, (b) highly effective at removing a wide range of fluoride concentrations, (c) culturally appropriate, (d) technically feasible and robust in a rural setting, and (e) operated and maintained with minimal manpower.

Our study argues that bauxite is cost-competitive with activated alumina by demonstrating: significant cost reduction for fluoride remediation using bauxite as an alternative to activated alumina in simple synthetic, complex synthetic, and real groundwater matrices, differences in fluoride removal performance between varying sources of global bauxites (e.g. Africa, USA, India), and similar kinetics of fluoride removal using activated alumina and African bauxite in synthetic groundwater.

### Materials and Methods

### Adsorbents Preparation

Global raw bauxite ores were collected from mines in North America (Alabama, USA), Africa (Guinea), and Asia (Visakhapatnam, India). Each sample was oven dried at 100° C. for 24 hours to remove any moisture and later milled for 60 minutes using an agate SPEX8000 ball mill to generate micron sized powders. The activated alumina and gibbsite powder reagents were purchased from Sigma Aldrich and used directly as packaged without any prior treatment.

### Solutions Preparation

The initial pH of all tested waters was set to 6. Real groundwater samples were collected from borwells in India (Nalgonda District and West Bengal) and characterized using ICP-AES. The simple groundwater matrix was prepared from dilution of stock solutions of NaF, NaCl and NaHCO₃ to achieve a composition of 10 ppm F⁻, 5 mM alkalinity, and 35 mM NaCl. More complex synthetic groundwater recipes taken from the British Geologic Survey's “Fluoride in Natural Waters” report (Edmunds and Smudley, 2013) were amended to have an initial fluoride concentration of 10 ppm F⁻ and prepared with stock solutions of CaCl₂, MgCl₂, NaHCO₃, Na₂SO₄, SiO₂ (Na₂SiO₃-5H₂O) and NaNO₃ to represent groundwater from Ghana, Sri Lanka, and Tanzania. See Table 1.0

TABLE 1

| | Synthethic Groundwater | | | | Real Groundwater | |
|---|---|---|---|---|---|---|
| Parameter | S1. Simple | S2. Ghana | S3. Sri Lanka | S4. Tanzania | R1. Telangana | R2. West Bengal |
| Fluoride (mg/L) | 10 | 10 | 10 | 10 | 8.4 | 6.2 |
| Ca (mM) | | 0.7 | 4.3 | 0.6 | 0.88 | 0.19 |
| Mg (mM) | | 0.6 | 7.4 | 0.1 | 1.44 | 0.03 |
| Si (mM) | | 1.2 | 1.6 | 1.9 | 1.25 | 0.38 |
| HCO₃₋ (mM) | 5 | 2.4 | 8.5 | 13.8 | | |
| SO₄²⁻ (mM) | | 0.0 | 0.2 | 0.2 | | |
| NO₃⁻ as N (mM) | | 0.4 | 0.6 | 0.6 | | |
| Ionic Strength | 40 | 21.8 | 64.4 | 40.8 | | |

### Batch Adsorption Experiments

All batch adsorption experiments were conducted in 15 mL falcon tubes and mixed thoroughly for the duration of the experiments using a Scilogex MX-RL-E Analog Rotisserie Tube Rotator (Rocky Hill, Conn.). At the completion of each experiment, samples were filtered using 2 μm syringe filters and mixed in equal volumes with TISABII, a buffer agent that complexes aluminum and provides constant background ionic strength. Final free-fluoride (F⁻) concentrations were measured using a Mettler Toledo Seven Multi fluoride probe (i.e., ion selective electrode). Final dissolved Al concentrations in filtered samples acidified using 1:5 volume ratio of acid to sample were measured using inductively coupled plasma atomic emission spectroscopy (ICP-AES).

To compare the performance and cost effectiveness of using of Activated Alumina versus African bauxite, we conducted adsorption experiments by reacting these adsorbents with simple synthetic, complex synthetic, and real groundwater matrices for 24 hours to ensure equilibrium was reached. The minimum dose was identified as the grams of adsorbent per liter after which the final equilibrium fluoride concentration reached below the WHO-MCL of 1.5 ppm F⁻. We then conducted similar adsorption experiments to compare the fluoride removal performance of different global bauxites (Africa, USA, and India) in simple groundwater and synthetic Sri Lankan water.

To further demonstrate proof of concept of using bauxite in a practical field setting, we compared the kinetics of fluoride removal in synthetic Sri Lankan water using the minimum required doses of African Bauxite and activated alumina by measuring fluoride concentrations at t=1, 3, 5, 8, 24 hr.

### Results and Discussion

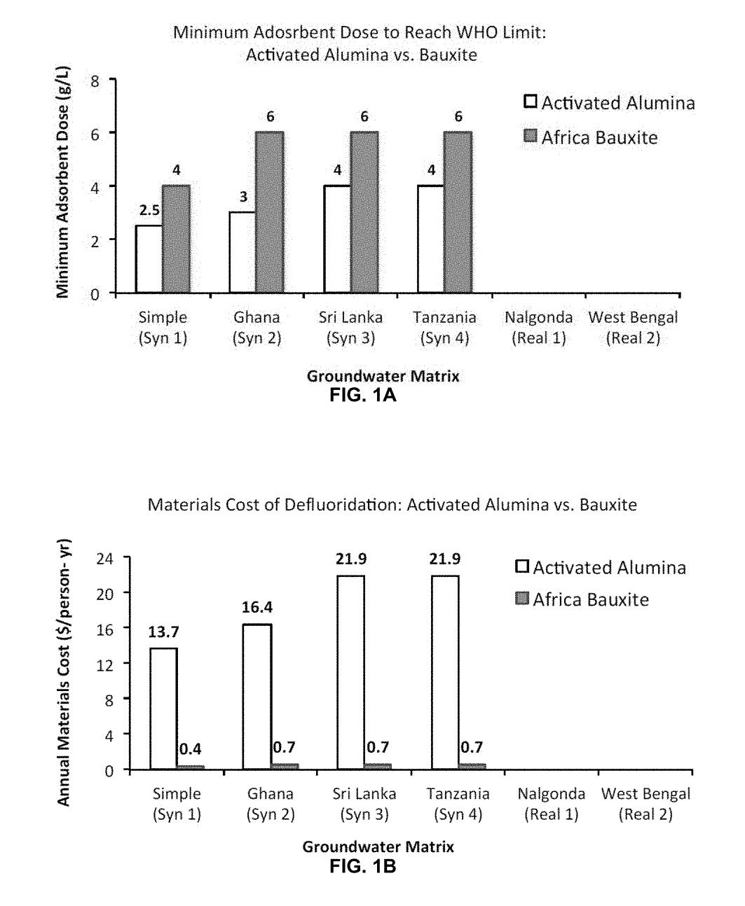

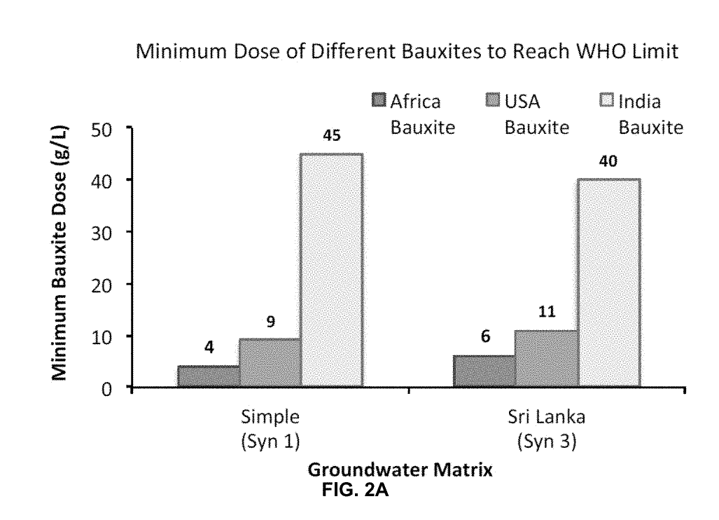

FIG. 1A shows the minimum doses of activated alumina and African bauxite required to reach 1.5 ppm F⁻ in simple and complex synthetic and real groundwater. FIG. 1B shows that even in presence of other co-occurring (potentially competitive) ions, African bauxite continues to be extremely cost competitive with activated alumina across a wide range of groundwater matrices.

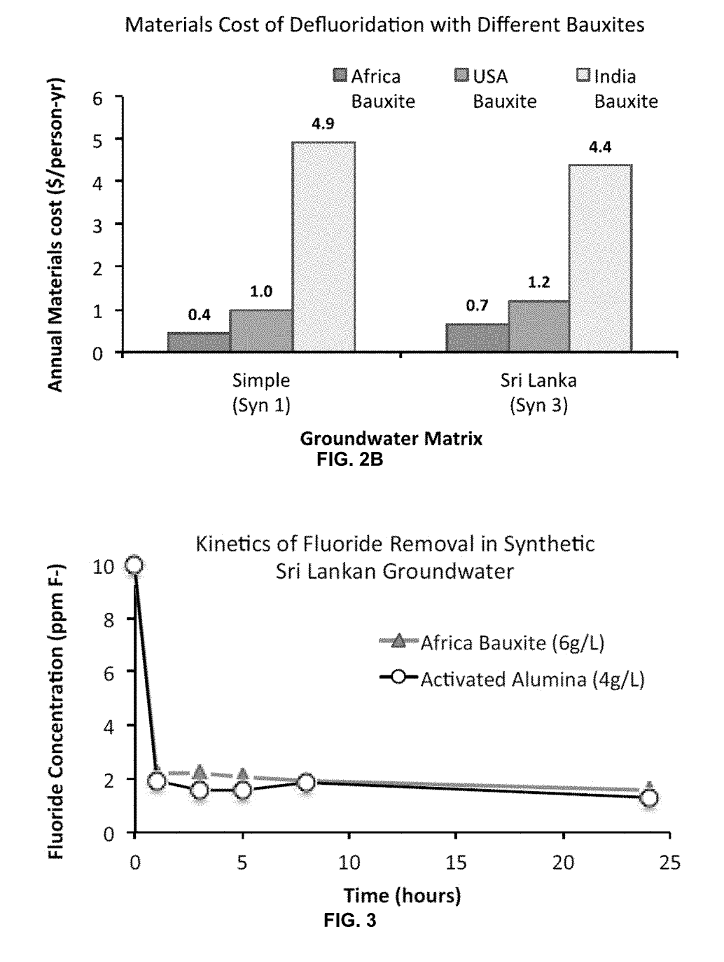

In FIG. 2A and FIG. 2B we show how global bauxite samples can differ in performance dramatically and hint that final pH is a potential indicator of these differences. Despite the difference in performance, all three types of bauxite from Africa, USA, and India remain cost competitive with activated alumina (i.e., India bauxite is still <$5/person year while activated alumina is $20/person year).

In FIG. 3 we use the minimum doses identified in FIG. 1A and FIG. 1B to show minimal differences in kinetics between African bauxite and Activated Alumina. The fact that both adsorbents behave similarly in Sri Lankan groundwater gives us confidence that their treatment processes would require a similar contact time for fluoride removal. 80% of removal occurs within the first hour.

### Practical Implications

This analysis shows that mildly processed bauxite works as an effective adsorbent in the presence of various groundwater ions and can serve as a cost competitive alternative to activated alumina.

### Example 2

Globally, 200 million people are at risk of developing fluorosis by drinking groundwater contaminated with toxic fluoride concentrations exceeding the World Health Organization's recommended level (WHO-MCL=1.5 mg F/L). Although many defluoridation technologies have been demonstrated to work in lab, most are inappropriate for developing countries because they are cost-prohibitive, labor intensive, or difficult to scale up. The use of mildly-processed bauxite, a ubiquitous aluminum-rich ore, to remediate fluoride through a batch adsorption process. Eliminating the energy-intensive process of refining bauxite to activated alumina (AA), a common adsorbent, has the potential to reduce the annual per-capita cost of treated water significantly. Experimental results indicate that bauxite ores from Guinea, USA, and India can remediate field-relevant fluoride concentrations in synthetic and real groundwater matrices much more inexpensively than treatment with AA. Findings suggest deployment of mildly-processed bauxite as an effective adsorbent material for groundwater defluoridation in fluoride-impacted, low-income regions.

### Introduction

200 million people worldwide drink groundwater contaminated with toxic fluoride levels^{[1]} surpassing the World Health Organization's maximum recommended contaminant level (WHO-MCL)^{[2]} of 1.5 mg F⁻/L. Although fluoride at low concentrations (<1 mg FM) is often intentionally added to drinking water supplies to prevent dental caries, exposure to excessive fluoride concentrations can cause detrimental health effects, including anemia and low IQ due to poor nutrient absorption, mottling of tooth enamel (dental fluorosis), and irreversible bone deformities in children (skeletal fluorosis)^{[3]}. Dissolution of fluoride-rich granitic rocks in groundwater aquifers^{[4]} causes excessive levels of fluoride in arid regions of India, China, the East African Rift Valley, the Middle East, northern Mexico, and central Argentina^{[5]}. Although many technologies have proven to be effective in the lab, most are neither sustainable nor effective in remote rural areas of developing countries because they are cost-prohibitive or dependent on intensive skilled labor for maintenance e.g., Nalgonda technique^{[5]}, reverse osmosis, and activated alumina^{[6]}), difficult to source and culturally inappropriate (e.g., bone char^{[6]}), or unreliable and difficult to scale up at the community level (e.g., rainwater harvesting)^{[7]}.

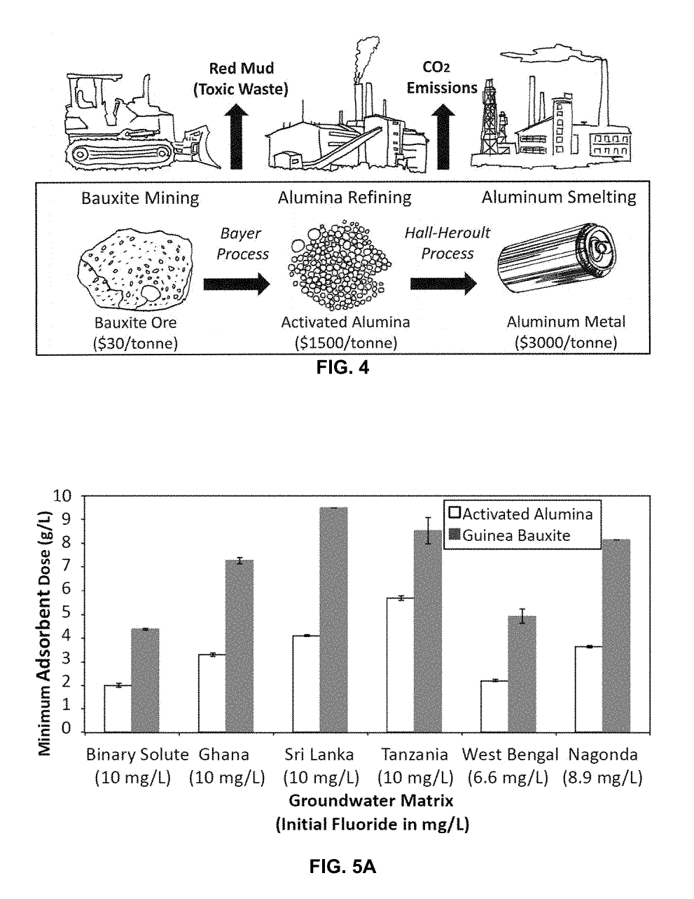

Among existing technologies, activated alumina column filters and aluminum electrocoagulation are widely used due to their relative affordability for the upper middle class, effectiveness, and fluoride's chemical affinity for aluminum^{[8]}. However, the industrial methods used to produce activated alumina (AA) and aluminum metal (Al) from bauxite ore (i.e., Bayer Processand Hall-Héroult Process) are extremely resource-intensive in terms of money, energy, and greenhouse gas emissions^{[9]} (FIG. 4). Per ton, alumina and aluminum respectively cost approximately 10×^{[10]} and 100×^{[11]} more than raw bauxite, revealing the steep cost of each subsequent processing step. Once alumina is further activated to make the commonly-used filter media, its final material cost ($1500/tonne)^{[12]} is 50× more expensive than raw bauxite ore ($30/tonne)^{[10]}.

Previous studies using bauxite from Ghana, Malawi, Tanzania, USA, India, Iran, and Turkey as an adsorbent have required energy-intensive processes like high thermal activation (e.g., calcination at T>1100° C.) or chemically-intensive processes using caustic sodium hydroxide to increase the purity of bauxite and concentrate aluminum content^{[13-20]}. The present invention provides for an ultra-low cost and highly effective fluoride adsorbent using inexpensively processed bauxite to eliminate the costly, wasteful, and unnecessary processes of refining bauxite into higher-end aluminum-based adsorbents. Existing literature fails to demonstrate that raw or mildly-processed bauxite can produce the desired level of fluoride removal and does not identify methods to improve fluoride removal performance across diverse sources of raw bauxite, which vary significantly in physical and chemical composition.

Processing bauxite minimally and avoiding both high temperature calcination and caustic sodium hydroxide has the potential to create a fluoride adsorbent that is (a) locally available and affordable, (b) highly effective at removing a wide range of fluoride concentrations, (c) culturally appropriate, (d) technically feasible and robust to implement in a rural setting, and (e) compatible with a defluoridation process operated and maintained without sophisticated training. In addition to the dramatic cost-reduction potential of this novel approach in comparison to other aluminum-based methods, bauxite deposits are ubiquitous and deposits are often near regions of excess fluoride concentrations. For instance, India has over 66 million people facing significant risk of adverse socioeconomic and health outcomes from fluorosis^{[21]} and is also home to the 5th largest bauxite deposit (3037 million tonnes) globally^{[22]}.

This example shows that mildly-processed bauxite is cost-competitive to activated alumina by demonstrating (1) significant reduction in material costs for fluoride remediation using bauxite as an alternative to AA in synthetic and real groundwater matrices, (2) modest (and acceptable) differences in fluoride removal performance between various global sources of bauxites from Guinea, USA, India, and (3) similar kinetics of fluoride removal using AA and Guinea bauxite in synthetic groundwater.

### Materials and Methods

Adsorbents Preparation.

Globally diverse bauxite ores are collected from mines in Guinea (Boke), USA (Alabama), and India (Visakhapatnam), referred to herein as Guinea bauxite, US bauxite, and India bauxite respectively. After oven-drying the raw bauxite at 100° C. for 24 hours to remove moisture, 5 g of each sample is milled for 60 minutes using an agate ball mill (SPEX8000) to generate micron sized powders. All bauxite samples are used as milled powders in all experiments. An activated alumina (AA) reagent is used as received (packaged as 1 μm porous powder by Sigma Aldrich).

Solutions Preparation.

A synthetic binary-solute groundwater matrix is prepared from dilution of stock solutions of NaCl and NaHCO₃ targeting a composition of 35 mM (2021 mg/L) NaCl and 5 mM (305 mg/L) alkalinity. Recipes for synthetic groundwater from Ghana, Sri Lanka, and Tanzania are developed based on measurements from the British Geologic Survey (BGS)^{[23]} and prepared using stock solutions of CaCl₂, MgCl₂, NaHCO₃, Na₂SO₄, SiO₂(Na₂SiO₃-5H₂O) and NaNO₃ (Table 2). Real groundwater samples from Nalgonda District and West Bengal, India are collected after the borewells are first pumped for several minutes and stored in sealed plastic bottles until later characterization.

TABLE 2
Chemical composition of synthetic and real groundwater matrices
used in this Example.^{a}

| Parameter | Synthetic Groundwater | | | | Real Groundwater^{b} | |
|---|---|---|---|---|---|---|
| (mg/L) | Binary Solute | Ghana | Sri Lanka | Tanzania | West Bengal | Telangana |
| F | 10.0 | 10.0 | 10.0 | 10.0 | 6.2 ± .62^{c} | 8.4 ± 0.8 |
| Ca | 0.0 | 27.6 | 173.0 | 17.6 | 8.0 ± 0.8 | 19.7 ± 2.0 |
| Mg | 0.0 | 13.7 | 179.0 | 1.4 | 1.0 ± 0.1 | 35.1 ± 3.5 |
| Si | 0.0 | 34.4 | 45.0 | 54.2 | 11.0 ± 1.1 | 35.1 ± 3.5 |
| HCO₃⁻ | 305.1 | 146.0 | 516.0 | 845.0 | — | — |
| SO₄²⁻ | 0.0 | 1.7 | 15.5 | 20.8 | — | — |
| NO₃⁻ as N | 0.0 | 4.9 | 9.0 | 7.8 | — | — |
| NaCl | 2021.3 | 0.0 | 0.0 | 0.0 | — | — |
| Fe | 0.0 | 0.0 | 0.0 | 0.0 | 0.0 ± 0.01 | 0.0 ± 0.01 |
| P | 0.0 | 0.0 | 0.0 | 0.0 | 0.1 ± 0.01 | 0.0 ± 0.01 |

^{a}Values reported are gravimetric target concentrations or measured concentration with errors.
^{b}Dashes indicate that the ions are not expected or measured.
^{c}Errors represent the larger of the standard deviation from repeated tests and ±10% ICP-AES measurement errors stored in sealed plastic bottles until later characterization.

Chemical Analysis.

The initial fluoride concentrations of all lab-synthesized groundwaters is set to 10 (±0.5) mg/L F⁻ using a stock solution of 100 mg/L NaF. Total final free-fluoride (F—) concentrations of filtered aliquots mixed with an equal volume of TISABII (a buffering agent that provides constant background ionic strength and complexes aluminum) are measured using a fluoride ion selective electrode (Mettler Toledo Seven Multi, perfect ION™). The initial pH of all tested waters is set to 6 (±0.1) by addition of 1M HCl and 1M NaOH as appropriate and is measured using a Consort meter (R3620). Concentrations of ions (e.g., Fe, Ca, Mg, Si, and P) are characterized in real groundwater samples using Inductively Coupled Plasma Atomic Emission Spectroscopy (ICP-AES) (USEPA Method 200.7)^{[24]}. Reported error for ICP-AES is ±10%.

Batch Adsorption Experiments.

All batch adsorption experiments are conducted in 15 mL polypropylene falcon tubes (Fischer Scientific) and maintained well-mixed using an Analog Rotisserie Tube Rotator (Scilogex, MX-RL-E). At the completion of each experiment, 5 mL aliquot from each slurry is collected in a syringe and filtered using 2 μm filters to remove colloidal particles before fluoride analysis.

Performance and Cost Comparison to Activated Alumina.

To compare the fluoride removal performance of mildly-processed bauxite to AA, 24-hour equilibrium adsorption experiments are conducted by measuring the fluoride removal by unmodified AA reagent and milled Guinea bauxite for each matrix listed in Table 2. In each case, the minimum adsorbent dose (as grams adsorbent per liter water) is that required to remediate 10 mg/L F to the WHO-MCL (1.5 mg/L F⁻). This dose is determined by interpolating from linear fit to the data of three separate doses remediating F⁻ from just above to just below the WHO-MCL for each adsorbent. The reported error represents the standard deviation between the interpolated doses from replicate experiments. Cost-effectiveness calculations compare the per capita annual material cost of each adsorbent added as a one-time-use powdered material (i.e., batch “dispersive” mode) and assume the daily WHO requirement for drinking water (7.5 L/person/day)^{[25]} and current material market prices of activated alumina (1.5/kg)^{[12]} and bauxite ($0.03/kg)^{[10]}. The cost of AA used as a regenerative filter media (i.e., surface sites restored through NaOH wash) is calculated by assuming only 75% of AA capacity is used in a column before breakthrough, each regenerated batch recovers its capacity by 70% relative to the previous value, and after 4 cycles, AA is discarded. A 2014 EPA report on AA provides support for the assumptions and additional details on relevant factors that is not taken into account in these simplified calculations, such as the efficiencies of acid/base regeneration of the media and material losses during treatment^{[12]}. Fluoride removal performances of milled Guinea, US, and India bauxite samples are compared in synthetic binary-solute and Sri Lankan groundwater matrices (defined in Table 2). The kinetics of fluoride removal is compared by measuring the fluoride concentration after 1, 3, 5, 8, and 24 hours in synthetic Sri Lankan groundwater using the minimum required doses of AA and milled Guinea bauxite respectively. The reported error represents the standard deviation of final measured fluoride concentrations from replicate batch tests.

### Results and Discussion

Minimum Adsorbent Dose and Cost Effectiveness.

The minimum dose of Guinea bauxite required to remediate art initial fluoride concentration of 10 mg/L to the WHO-MCL of 1.5 mg/L in a batch dispersion process (i.e., with no regeneration) is about twice the minimum required dose of AA in all tested groundwater matrices (FIG. 5A). An increase in this required dose for both AA and milled Guinea bauxite is observed as they move from binary-solute groundwater to more complex BGS synthetic groundwater and real groundwater. This is likely due to the presence of potentially competitive species such as divalent cations (e.g., Ca²⁺ and Mg²⁺), oxyanions SiO₄⁴⁻, HCO₃⁻, SO₄²⁻, NO₃⁻), and natural organic matter (likely to be present in field samples). The material cost of treating water with milled Guinea bauxite is consistently and dramatically lower than with AA across all tested groundwater matrices, whether AA is assumed used in a dispersive batch mode or a regenerative column filter mode (FIG. 5B). Even in the most conservative case when the AA is used in a regenerative mode (and the annual material cost of AA is reduced by about a factor of 2 compared to that of AA in a one-time use in a dispersive mode), its cost still remains much higher than the annual cost of Guinea bauxite in one-time use in a dispersive mode. These results call attention to the need to understand the regenerative capacity of mildly-processed bauxite adsorbent through future studies using strong bases to remove the adsorbed fluoride, creating vacancies in the available surface sites for reuse and further reducing the cost.

Performance Comparison of Globally-Diverse Bauxites.

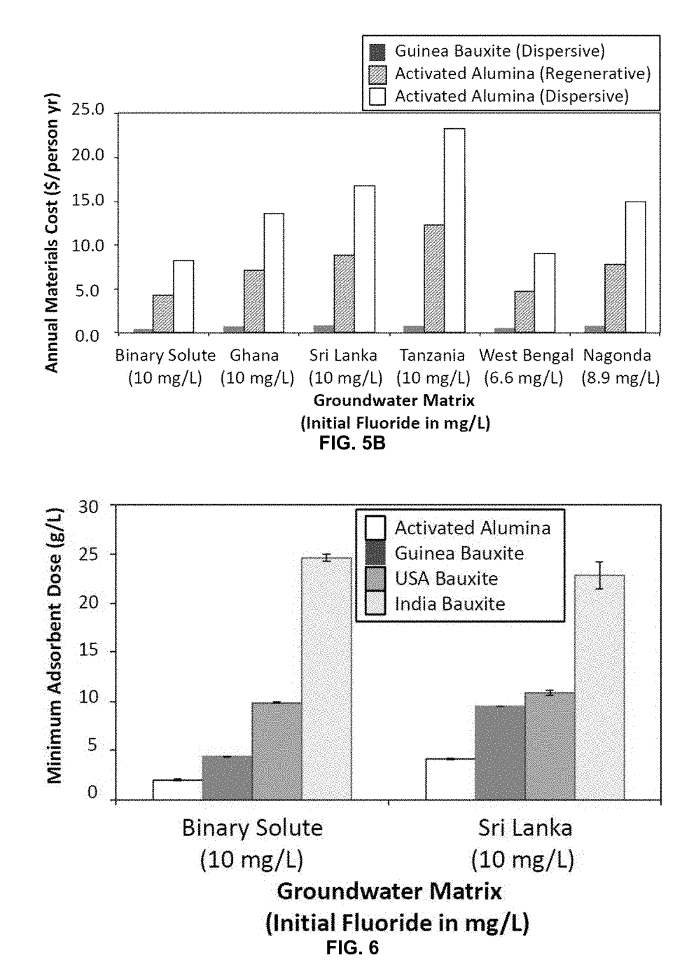

Large differences in the minimum required dose to remediate fluoride to the WHO-MCL with bauxite samples from three globally diverse sites are measured, in both the simple synthetic binary-solute and complex synthetic Sri Lankan groundwater matrices (FIG. 6). Despite these differences, all bauxite samples remain cost competitive with AA. Of the three sources, the milled India bauxite requires the largest dose (˜25 g/L) compared to milled Guinea bauxite (<10 g/L) in both matrices. The importance and interplay of several defluoridation-relevant properties of bauxite that tend to vary with source location (e.g., pH, natural organic matter content, mineralogy, surface area) are currently under investigation.

Fluoride Removal Kinetics.

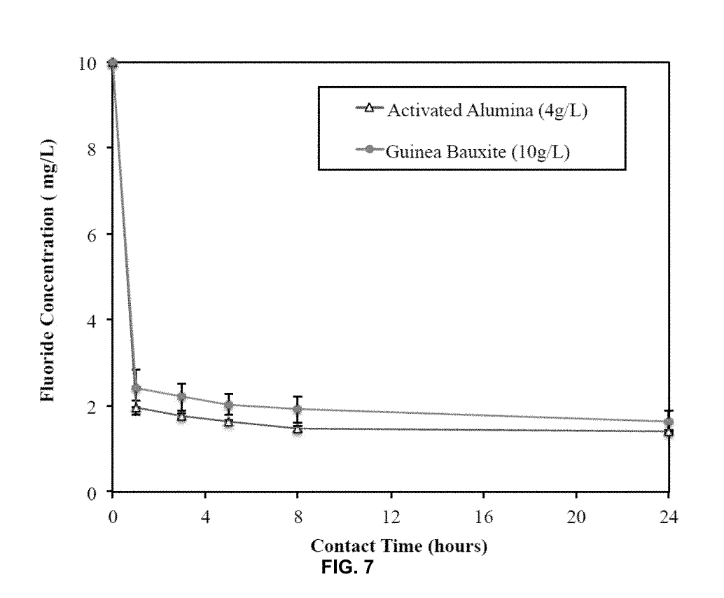

A negligible difference in fluoride removal kinetics between Guinea bauxite and AA in the synthetic Sri Lankan groundwater matrix (FIG. 7) is measured. The fact that both adsorbents behave similarly in a realistic groundwater matrix provides confidence that their treatment processes would require a similar contact time for fluoride removal in the field. As indicated in FIG. 7, approximately 80% of the expected fluoride removal takes place within the 1st hour. This finding of a relatively short contact time is advantageous for the eventual field implementation of this system as a batch dispersive-mode media.

Future Implications.

The potential to use bauxite as an ultra-low cost alternative to AA for fluoride removal targeting rural, remote, and impoverished regions of the world suffering from fluoride-contaminated groundwater sources is evaluated. These findings provide evidence that mildly-processed bauxite works as an effective fluoride removal adsorbent capable of remediating high fluoride levels (up to 10 mg/L) to the WHO-MCL, even in the presence of various relevant groundwater ions. Based on this analysis, mildly-processed bauxite sourced from Guinea, the US, or India could serve as a cost-competitive alternative to AA.

A deeper understanding of differences in mineralogy, porosity, pH, and other factors between bauxite sources and how those factors impact the mechanisms of fluoride removal is needed to further improve overall performance. Rigorous lab analysis and field-testing must be completed before implementing this novel bauxite-based defluoridation technology at a pilot scale. For example, it is important to identify lower cost methods for solids separation (such as settling tanks or slow-sand filtration) and to explore the potential resale of fluoride-laden bauxite sludge to aluminum manufacturing companies to further reduce the fiscal and environmental impact of implementing this technology. Based on previous studies of similar water treatment systems implemented in the developing world, a possible application of this technology as a community scale batch reactor system with a field-applicable delivery mode (e.g., sale at kiosks or delivery via jerry cans) is envisioned.

### REFERENCES CITED IN EXAMPLE 2

[1] Edmunds, M.; Smedley, P. Chapter 12: Essentials Of Medical Geology: Impacts of the Natural Environment on Public Health; Selinus, O.; Alloway, B. J., Eds.; 1st ed.; Elsevier Academic Press: Amsterdam; 2005.
[2] Fawell, J. K.; Bailey, K. Fluoride In Drinking-Water; WHO Water Series; IWA Pub.: London, 2006.
[3] Ozsvath, D. L. Fluoride And Environmental Health: a Review. Rev in Environ. Sci. Biotechnol. 2009, 8, 59-79.
[4] Saxena, V.; Ahmed, S. Inferring The Chemical Parameters for the Dissolution of Fluoride in Groundwater. Environ. Geol. 2003, 43, 731-736.
[5] Jagtap, S.; Yenkie, M. K.; Labhsetwar, N.; Rayalu, S. Fluoride in Drinking Water and Defluoridation of Water. Chem. Rev. 2012, 112, 2454-2466.
[6] Osterwalder, L.; Johnson, C. A.; Yang, H.; Johnston, R. B. Multi-criteria Assessment of Community-Based Fluoride-Removal Technologies for Rural Ethiopia. Sci. Total Environ. 2014, 532-538.
[7] Mwenge, K. J.; Taigbenu, A. E.; Boroto, J. R. Domestic Rainwater Harvesting to Improve Water Supply in Rural South Africa. Phys. Chem. Earth Parts ABC. 2007, 32, 1050-1057.
[8] Chauhan, V. S.; Dwivedi, P. K.; Iyengar, L. Investigations on Activated Alumina Based Domestic Defluoridation Units. J. Hazard. Mater. 2007, 139, 1, 103-107.
[9] Chen, W. Q.; Graedel, T. E. Dynamic Analysis of Aluminum Stocks and Flows in the United States: 1900-2009. Ecol. Econ. 2012, 81, 92-102.
[10] Bray. L. USGS Mineral Commodities Summaries 2015: Bauxite and Alumina; rep., United States Geologic Survey, 2016.
[11] Aluminium Price Per Tonne. Alibaba, the website for: alibaba.com/ (accessed Jan. 1, 2016).
[12] Sorg, T. Removal of Fluoride from Drinking Water Supplies by Activated Alumina; publication; US EPA, 2014.
[13] Buamah, R.; Mensah, R. A.; Salifu, A. Adsorption of Fluoride from Aqueous Solution Using Low Cost Adsorbent. Water Sci. Technol. Water Supply. 2013, 13, 2, 238.
[14] Kayira, C.; Sajidu, S.; Masamba, W.; Mwatseteza, J. Defluoridation of Groundwater Using Raw Bauxite: Kinetics and Thermodynamics. CLEAN—Soil Air Water. 2014, 42, 5, 546-551.
[15] Sajidu, S.; Masamba, W.; Thole, B.; Mwatseteza, J. Groundwater Fluoride Levels in Villages of Southern Malawi and Removal Studies Using Bauxite. Int. J. Phys. Sci. 2008, 3, 1, 1-11.
[16] Thole, B.; Mtalo, F.; Masamba, W. Groundwater Defluoridation with Raw Bauxite, Gypsum, Magnesite, and Their Composites. CLEAN—Soil Air Water, 2012, 40, 11, 1222-1228.
[17] Lavecchia, F. M. R. Fluoride Removal from Water by Adsorption on a High Alumina Content Bauxite. Chem. Eng. Trans. 2012, 26, 225-230.
[18] Sujana, M. G.; Anand, S. Fluoride Removal Studies from Contaminated Groundwater by Using Bauxite. Desalination, 2011, 267, 2, 222-227.
[19] Malakootian, M.; Javdan, M.; Iranmanesh, F. Fluoride Removal from Aqueous Solutions Using Bauxite Activated Mines in Yazd Province. J. Community Health Res. 2014, 3, 2, 103-114.
[20] Atasoy, A. D.; Yesilnacar, M. I.; Sahin, M. O. Removal of fluoride from contaminated ground water using raw and modified bauxite. Bull. Environ. Contam. Toxicol. 2013, 91, 5, 595-599.
[21] UNICEF 1999 State of Art Report on Extent of Fluoride In Drinking Water and the Resulting Endemicity in India; rep.; Fluorosis Research and Rural Development Foundation for UNICEF: New Delhi, 1999.
[22] Detailed Information on Bauxite in India; rep.; Geologic Survey of India, 1994.
[23] Edmunds, M.; Smedley, P. Chapter 12: Essentials Of Medical Geology: Impacts of the Natural Environment on Public Health; Selinus, O.; Alloway, B. J., Eds.; 1st ed.; Elsevier Academic Press: Amsterdam, 2005.
[24] US EPA Clean Water Act Analytical Method 200.7: Determination of Metals and Trace Elements in Water and Wastes by Inductively Coupled Plasma-Atomic Emission Spectrometry; Rev. 4.4. US EPA, 1994.
[25] World Health Organization, Guidelines for drinking-water quality; 4th ed.; rep.; WHO: Geneva, 2011.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

We claim:

1. A system for removing a fluoride ion from an aqueous solution, comprising: (a) an aqueous solution comprising a fluoride ion, and (b) a bauxite mineral; wherein the aqueous solution has a pH with a value in the range of from about 5.5 to about 8.5, and the system is capable of achieving an aqueous solution having a fluoride concentration of equal to or less than 1.5 ppm.

2. The system of claim 1, wherein the system is capable of achieving an aqueous solution having a fluoride concentration of equal to or less than 1.0 ppm.

3. The system of claim 1, wherein the global bauxite mineral is first heated at a temperature equal to or more than about 300° C. prior to introduced or mixed with the aqueous solution.

4. The system of claim 1, wherein the aqueous solution has a pH with a value in the range of from about 5.5 to about 7.5.

5. The system of claim 4, wherein the aqueous solution has a pH with a value in the range of from about 5.5 to about 6.5.

6. The system of claim 5, wherein the aqueous solution has a pH with a value of about 6.0.

7. A method for removing a fluoride ion from an aqueous solution comprising: (a) providing an aqueous solution comprising a fluoride ion; (b) introducing a bauxite mineral to the aqueous solution; (c) adjusting the pH of the aqueous solution to a value in the range of from about 5.5 to about 6.5 such that the fluoride ion binds to the bauxite mineral to form a bauxite-fluoride complex, wherein the fluoride ion adsorbs and forms an innerspace aluminum-fluoride complex; (d) optionally incubating the aqueous solution for a period of time sufficient for the fluoride ion to bind to the bauxite mineral to form the bauxite-fluoride complex; (e) separating the bauxite-fluoride complex from the aqueous solution to produce a fluoride ion reduced aqueous solution, such that the fluoride ion reduced aqueous solution has a fluoride content of equal to or less than 1.5 ppm; (f) optionally adjusting the pH value of the aqueous solution to a value in the range of from about 6.5 to about 7.5; and (g) optionally extracting alumina (Al₂O₃) and/or aluminum from the bauxite-fluoride complex. In some embodiments, the fluoride ion reduced aqueous solution has a fluoride content of equal to or less than 1.0 ppm.

8. A method for removing a fluoride ion from an aqueous solution comprising: (a) providing an aqueous solution comprising fluoride, one or more cations, such as calcium and magnesium, and one or more anions, such as bicarbonate and sulfate; (b) introducing a processed bauxite mineral to the aqueous solution via a batch or continuous addition process, wherein the processed bauxite mineral to account for native pH and mineralogy differences depending on the type of bauxite used, such that the processed bauxite mineral and the fluoride ion complex to form a solid precipitate; and (c) separating the solid precipitate from the aqueous solution, such that the resulting aqueous solution has a fluoride content of equal to or less than 1.5 ppm.

9. The method of claim 8, wherein the resulting aqueous solution has a fluoride content of equal to or less than 1.0 ppm.

10. The method of claim 8, wherein the method is a continuous process, wherein the method takes place in a reactor, step (b) results in a bauxite slurry wherein processed bauxite mineral is continuously introduced to the bauxite slurry, and step (c) results in the solid precipitate being continuously separated from the bauxite slurry.

11. The method of claim 8, wherein the aqueous solution is naturally occurring groundwater contaminated with fluoride ions.

12. The method of claim 8, wherein the separating step (c) comprises using a sedimentation or post treatment filtration process to remove solid precipitates from the treated solution. In some embodiments, processed bauxite mineral is formed by (i) burning off organic matter at a temperature equal to or more than 200° C., or (ii) milling the processed bauxite mineral into a plurality of particles having (1) an average particle size with a maximum linear dimension of equal or less than 50 μm, or (2) a maximum linear dimension of equal or less than 50 μm, and introducing one or more acidic functional groups to the surface of the particles.

13. A method for removing naturally relevant concentrations of fluoride ions from contaminated groundwater comprising: (a) providing an aqueous solution comprising fluoride and bicarbonate, calcium, magnesium, or sulfate; (b) introducing a processed bauxite mineral to the aqueous solution via a batch or continuous addition process; and (3) using a sedimentation or post treatment filtration process to remove solid precipitates from the treated solution.
